(19) United States
(12) Patent Application Publication
(10) Pub. No.: US 2010/0175103 A1
(43) Pub. Date: Jul. 8, 2010

(54) REACTIVE THROTTLING OF INBOUND MESSAGES AND RANGES

(75) Inventors: Jason D. Walter, San Jose, CA (US); Eliot C. Gillum, Mountain View, CA (US); Krishna C. Vitaldevara, Fremont, CA (US); Ryan Charles Colvin, Bothell, WA (US); Mehrdad Bidgoli, San Jose, CA (US); Chad Mills, Redmond, WA (US); Joshua David Korb, Issaquah, WA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 12/350,112

(22) Filed: Jan. 7, 2009

(51) Int. Cl. G06F 21/00

(52) U.S. Cl. 726/1

(57) ABSTRACT

A method for throttling inbound email messages in an enterprise email system including a plurality of inbound mail servers and at least one management server is provided. Policies defining message event limits for each unique sender are applied to messaging events from the unique sender at each inbound server. Feedback from each of the inbound mail servers to the management server is provided. When events from a unique sender exceed a threshold, as determined by the management server using the feedback, an alert is generated and a new, more restrictive policy for the unique sender is created. The more restrictive policy is broadcast the more restrictive policy to each of the inbound mail servers.

### BACKGROUND

Unsolicited Bulk Email (UBE) is a widespread problem. UBE may include unsolicited commercial email, spam and other unsolicited bulk emails. Originators of UBE (spammers) harness the processing power of numerous mail server machines to send UBE. Spammers can flood large mail processing systems to the brink of their inbound email capacity. Flooding mail processing systems in this manner results in less bandwidth made available to process legitimate email.

Large-scale Email Service Providers (ESPs) are disadvantaged in processing UBE by the sheer magnitude of their mailing infrastructure and inbound email accepting capacity. The mailing infrastructure of a large-scale ESP typically includes a number of mail transfer agents (MTAs).

Co-pending U.S. Application Publication no. US 2006/0224673 entitled “Throttling Inbound Electronic Messages in a Message Processing System”, having inventors Pablo M. Stern, Eliot C. Gillum, (Attorney Docket no. MSFT-01017US0) owned by the assignee of the present application and specifically incorporated by reference herein, discloses a system whereby rules are used for proactive and/or active processing of message events. Such message events can include electronic messages, email, connection requests, and other incoming message events. System processing of such events can include throttling and/or otherwise processing subsequent message events. Throttling subsequent incoming message events reduces the quantity of message events from a unique sender that are processed by a system.

### SUMMARY

Technology is described for improving the ability of a large scale email system to throttle messaging events. Policies limiting the number of messaging events are established for each unique sender interacting with the email system. The policies are distributed to processing devices receiving messaging events such as connection requests and email messages from sending servers. Real time feedback is provided to a messaging information system and if one of the unique senders exceeds their allocated event thresholds, a more restrictive policy may be implemented and broadcast to all other processing devices. Unique senders may be identified by individual IP addresses, or a range of IP addresses.

In one embodiment a method for throttling inbound email messages in an enterprise email system including a plurality of inbound mail servers and at least one management server is provided. Policies defining message event limits for each unique sender are stored at each of the inbound mail servers in the system. The policies are applied to messaging events from the unique sender and feedback from each of the inbound mail servers to the management server is provided. When events from a unique sender exceed a threshold, as determined by the management server using the feedback, an alert is generated and a new, more restrictive policy for the unique sender is created. The more restrictive policy is broadcast to each of the inbound mail servers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an enterprise email system.

FIG. 2 depicts a method occurring on an inbound mail server and a message information server in accordance with the present technology.

FIG. 3 illustrates a method for updating a global policy listing.

FIG. 4 illustrates a second method for updating a global policy listing.

FIG. 5 illustrated a portion of a global policy listing.

FIG. 6 is a diagram of a processing system suitable for implementing the technology described herein.

### DETAILED DESCRIPTION

Technology is described for improving the ability of a large scale enterprise email system to throttle messaging events. Policies limiting the number of messaging events are established for each unique sender interacting with the email system. The policies are distributed to processing devices receiving messaging events such as connection requests and email messages from sending servers. Real time feedback is provided to a messaging information system. If one of the unique senders violates its policy over a threshold amount, a more restrictive policy may be implemented for the sender and is broadcast to all other processing devices. Unique senders may be identified by individual IP addresses, or a range of IP addresses.

In accordance with the technology, a unique sender is a message event source identifier that is unique throughout the system. A unique sender may be identified as an IP source address, a domain, a range or group of IPs or some other information identifying a sender of a message event in a unique way. In this context, domain can refer to a PTR domain, a sender domain or a URL domain. In one embodiment, the electronic message events are email connection requests, but may also include electronic messages, and other events. Messaging events may include, but are not limited to, mail protocol events including connection request commands, data commands, and message data.

Email may be processed by an email system at mail transfer agents (MTAs). Connection requests may be processed by either the MTAs or by a router. The electronic message events are processed using default rules and/or policies, or rules or policies derived from the received electronic message information. A message information store receives the electronic message information, aggregates the information, develops rules from the information and transmits the rules to servers processing subsequent electronic messages and one or more routers.

In one embodiment, a large scale email system can have hundreds of MTAs used to process and forward incoming electronic messages to an electronic message store. A router within the mail system may receive incoming connection requests (intent on delivering electronic messages) and route them to the MTAs. Alternatively, connection requests are handled directly by inbound messaging servers. A message information store (MIS) receives message information from each MTA. The MIS aggregates the message information (for example, into a table) and generates rules for processing subsequent electronic messages and connection requests received by the mail system. The rules are derived from the aggregated message information and can be applied to electronic messages received from different electronic message sources (for example, different source IP addresses).

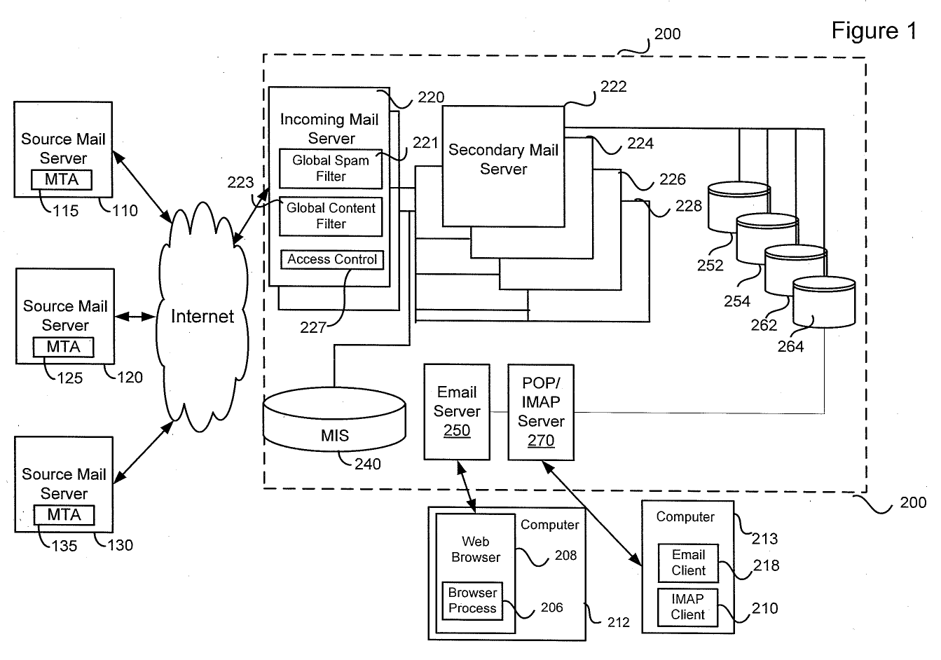

FIG. 1 is a block level diagram of a system suitable for implementing the present technology. System 200 which may be implemented by an email service provider (ESP) may consist of, for example, an inbound email MTA 220 which comprises a number of processing devices, one or more secondary MTAs 222, 224, 226, 228 and user data storage units 252, 254, 262, 264. An email server 250 and a POP/IMAP server 270 may also be provided which allow users to access their email data after an appropriate authentication. A message information store (MIS) may comprise one or more processing devices which process information provided by the MTA's and maintain data on unique senders. The MIS then generates processing policies or rules for each unique sender, or a range of unique senders, which may be transmitted to the MTAs. System 200 allows users operating processing devices 212, 213 to access their email data. It should be understood that users may connect to system 200 via any number of public or private networks, including the Internet.

The inbound email MTA 220 is essentially a front end or “edge” server to which email messages are transmitted via the Internet (or other suitable network) from sending servers 110, 120, 130, each having a respective MTA 115, 125, 135. The inbound MTA 220 handles connections from sending mail servers coupling to the inbound MTA via the Internet and performs an initial set of acceptance and filtering tasks on inbound email. An access control system 227, within each MTA, controls connection requests to the MTA from sending servers. Alternatively, a separate routing layer (not shown) may be utilized. In general, the MTA can accept or refuse the incoming connection request attempt in the host or via networking protocol.

Electronic messages are typically sent over the Internet using the simple mail transfer protocol (SMTP) standard. An electronic message sent via SMTP includes source information, recipient information and data information. The source information typically includes a source Internet Protocol (IP) address. The source IP address is a unique address from which the electronic message originated and may represent a single server, a group of servers or a virtual server. As such the unique sender may be identified by IP address or other means.

Inbound email MTA 220 may include an initial protocol and blacklist check (performed, for example, by the access control 227) to determine whether to allow an initial connection from the sending server 110, 120, 130. Inbound email MTA 220 may also include a global spam filter 221 and a global content filter 223. The global spam filter 221 is applied to incoming messages and associates a spam score with each message. The global content filter 223 may comprise any of a number of content filtering methods including for example, methods to determine if the message contains phishing content, suspect links or viral attachments.

If email is deemed deliverable, the inbound email MTA will forward messages to a second level, internal MTA 222, 224, 226, 228. Information on where to direct messages within the system may be provided by a user location database (not shown) which is a data store of storage location information for each of the users having a user account or email address within system 200. The user location database server stores information for allowing other servers in the system to direct mail within the system to storage locations on storage units 252, 254, 262, 264 based on the routing instructions in the system 200.

In accordance with the present technology, each unique sender may have associated with the sender a policy defining a total daily bandwidth allocation, a totally hourly bandwidth allocation, a total recipient per email message allocation, or any number of limit allocations. An exemplary policy is illustrated in FIG. 5.

The MIS maintains a global policy list for all sources seen by the system 200. With the data associated with each entry or range of entries, the global policy list for a system 200 of any significant size results in a rather large file—potentially on the order of tens or hundreds of megabytes. Transfer of the entire file in real time is impractical.

In accordance with the policy derived for the unique sender, policy information is maintained at each inbound MTA and applied by an access control layer, content filter or spam filter, or a combination of each, which are then used to apply the throttling policy to the unique sender. Each inbound MTA includes a copy of the global policy list, which is distributed periodically by the MIS.

Access to user data by the users is performed by the email server 250 or POP/IMAP server 270. Email server 250 may comprise a web server which provides an email interface to a web browser 208 which institutes a browser process 206 on a user computer 212. Email server 250 can render email data from the data storage units to a user using computer 212 to access the email system 200. Likewise POP/IMAP server 270 can provide email data to a POP email client 218 or an IMAP client 210 on user computer 213.

Technology is provided to increase the ability of each of the receiving MTAs to respond spikes in messaging events from a unique sender. In one aspect, real time feedback is provided to a tracking system, identified herein as the MIS, which can trigger a throttle event. The throttle event can be broadcast to all elements of the system having the ability to throttle messaging events. In a further aspect, throttling can occur by applying a processing rule to a range of unique senders, such as a range of IP addresses.

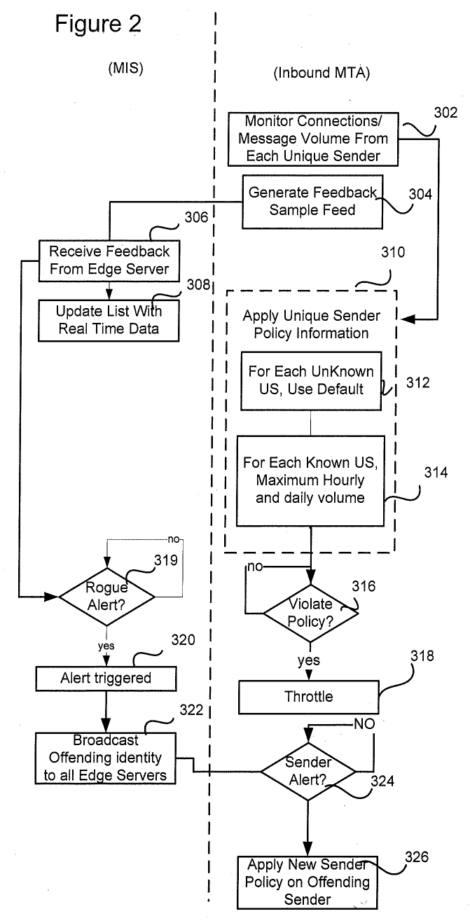

FIG. 2 illustrates a process, occurring for example on an inbound MTA and the MIS, to improve throttling in the system 200. At step 302, data concerning each connection is monitored and maintained by the inbound mail server. As discussed above, data is gathered from the SMTP conversation which occurs between the inbound MTA and the sending server. Data which is maintained includes, but is not limited to, the source IP of the server, the source domain of the sending server, the volume of messages sent by the unique server over a period of time, the number of connection requests made by the unique source over a period of time, and the number of recipients in messages transmitted by the unique source.

At step 304, feedback is provided to the MIS. As will be understood, in a large scale email system the volume of messages received by a number of Inbound MTAs is enormous. As a result, a sampling of the unique sender is sent back to the MIS at step 306. The size of the sampling may vary in accordance with the performance desired from the system. In an alternative embodiment, full data rather than a sampling may be returned to the MIS. In a further alternative embodiment, that sampling may be dynamic in any way agreed upon between MTA and MIS. As illustrated at step 308, the MIS can use this information to update the status list in real time.

At step 310, the MTA continuously applies unique sender policy information to connections requests, messages, or both. Application of policies or “rules” may occur in accordance with the teachings of Publication No. US 2006/0224673. As shown at step 312, for a connection from a new, unknown unique sender, a default policy is used. The default policy includes a reasonable allocation of bandwidth and messaging permissions which may be derived from statistics consistent with mail servers not used for UBE. For each known unique sender at step 314, the policy for the unique sender is used.

In the context of applying the policy at step 310, the unique sender may comprise, in one embodiment, an individual IP, a domain or multiple domains, or a range of IPs. The range of IPs may be derived based on statistics consistent with UBE seen from multiple IPs in having common characteristics which define a range or group.

As policies are applied by the Inbound MTA, at step 316 the inbound mail server will detect if a policy violation occurs at step 310. If a policy violation occurs, throttling occurs at step 318. Policies regulate, for example, a maximum number of connection requests per hour or day, a number of recipients or an allowed data connection limitation. If a unique sender exceeds the allowed number of connection requests, the policy may be enforced to simply drop connection requests exceeding the allowed limit. Similarly, if messages are received with more than an allowed number of recipients, the connection may be reset, forcing the sending email server to reconnect to complete delivery of the message. A sender attempting to exceed allowed number of SMTP DATA segments on one SMTP connection will see a connection dropped and the sender would to reconnect.

As shown at step 319, based on the feedback received at step 306, an alert may be generated by the MIS. A spike in activity from any unique sender will be reflected in the feedback received at step 306. While the MIS is not applying policy limits to connection requests or messages, it does maintain a policy list for all unique senders and thus can cull feedback from all the inbound servers to detect if a unique sender is adversely impacting the system. In one embodiment, the policy violation must exceed an alert threshold to generate the alert. The MIS uses the policy information and the unique sender information to determine, based on the violation magnitude and type of policy violation, whether to issue an alert to all inbound mail servers in the system 200. Messaging events limited by each unique sender policy are counted and if the count for a particular unique sender over a defined period exceeds a threshold, an alert is generated. It should be noted that in one alternative, a weighting of events based on frequency and type may be used in addition to or as a substitute for a simple count. If an alert is generated at step 320, at step 322, the MIS can alert all inbound servers to further restrict the activity of the offending unique sender. The alert at step 322 may, in one embodiment, take the form of a replacement policy severely limiting or completely blocking additional message events, blocking connection requests from the unique sender, or limiting the senders bandwidth by accepting a limited number of data as measured in bytes per unit time or varying the data block length allowed. In one embodiment, the alert is broadcast using UDP. Other connection protocols or transmission schemes may be utilized. Any plurality of replication mechanisms may be used or combined, including full or delta replication schemes which are file- or network-oriented.

With UDP, each inbound server listens for alert packets at step 324 and when one is received, the policy is immediately applied and updated at step 326. This substantially reduces the time required to provide throttling or blocking to a unique sender which is flooding the system 200 with UBE.

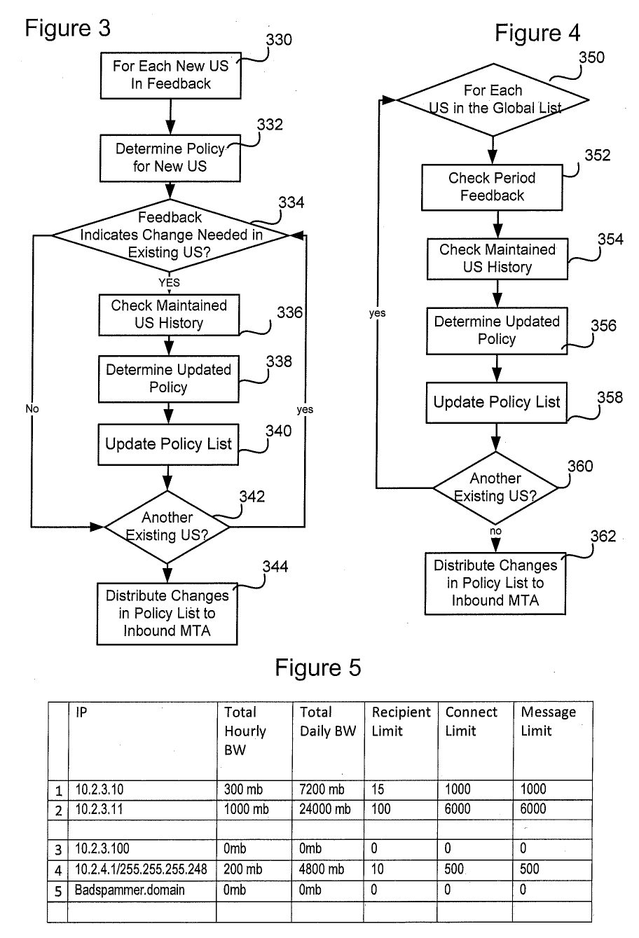

FIG. 3 illustrates a maintenance process occurring at step 308. When a new IP is seen in the feedback provided by the inbound server at step 330, a new policy is determined for the new IP and the policy data file is updated. Periodically, changes to the data list are distributed to the servers and the list maintained at the inbound servers is updated. The list update process may be performed by the MIS or performed by a separate dedicated administration server or servers (not illustrated).

At step 330, where new unique senders are found, at step 332, a new policy is installed for the new unique sender and the sender identification is added to the global list. At step 334, if the real time feedback indicates the need to change a policy for an existing IP, then the history for the unique sender is checked at step 336 along with feedback obtained and an updated policy is determined at step 338. The updated policy is added to the global list at step 340. If other existing unique senders need updating at step 342, steps 336-340 are repeated. The changes are distributed at step 344. Step 344 may occur by allowing the inbound message servers to query the MIS (or administration server) for the global list when convenient for the inbound server or at some periodic period.

FIG. 4 illustrates a less frequent, list rebuild process occurring, for example, during lower usage periods such as during early morning hours. At step 350, for each unique sender in the global list, feedback over a period (such as the last 24 hours) is checked at step 352 along with the maintained total history at step 354. A new policy is determined at step 356 and the global list updates at step 358. Steps 352, 354, 356 and 358 are repeated at step 360 until all entries are rebuilt. The changes are then distributed in a full or differential copy of the policy lest at 362.

FIG. 5 illustrates a sample of the records maintained in the global list. Three exemplary entries are shown. Entry 2 shows an unbounded or highly allowed unique sender. This sender has proven reliability in not sending UBE or may be defined as a partner or specially permitted unique sender for the provider of system 200. As a result, limits are set fairly high for this sender. Entry 1 illustrates a suspect unique sender. Some messages may have been valid mail while others have been UBE. Entry 3 indicates a blocked sender, and exemplifies a policy applied, for example, during an alert. Entry 4 shows a policy applied to a range of addresses defined by a base address and a net mask. In this entry, the limits on each policy characteristic are summed for all addresses matching those in the range. Other event limits (now shown) may be included in the record of FIG. 5, including, a total data amount per connection, a total time spent per connection, a total number of messages processed.

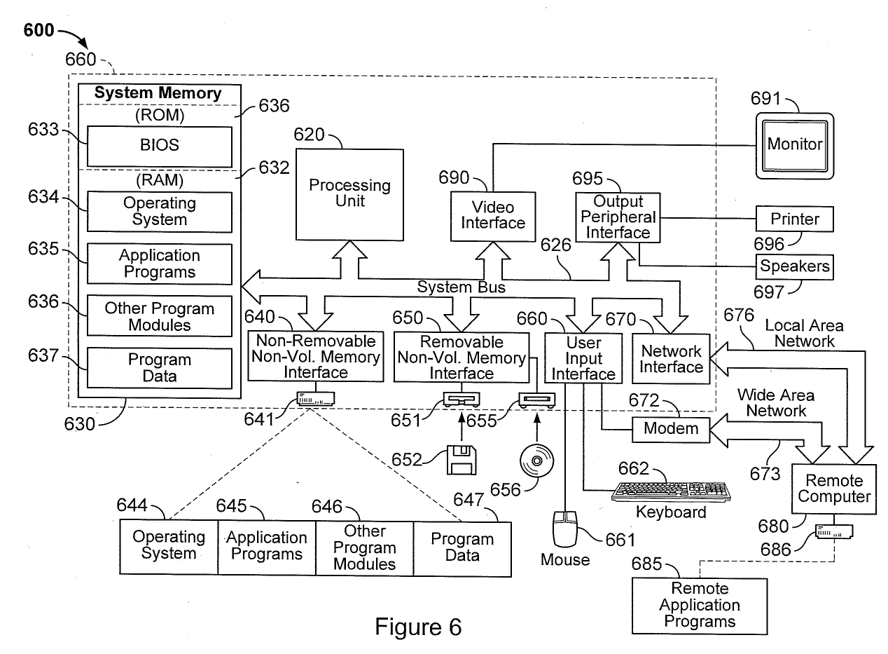

FIG. 6 is an exemplary processing system utilized in accordance with the present technology. FIG. 6 illustrates an example of a suitable computing system environment 100 such as a computer suitable for implementing any of the processing devices or servers described herein.

With reference to FIG. 6, an exemplary system for implementing the technology includes a general purpose computing device in the form of a computer 660. Components of computer 660 may include, but are not limited to, a processing unit 620, a system memory 630, and a system bus 626 that couples various system components including the system memory to the processing unit 620. The system bus 626 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 660 typically includes a variety of computer readable media. Computer readable media can be any available media that can be accessed by computer 660 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 660. Communication media typically embodies computer readable instructions, data structures, program modules or other data and includes any information delivery media. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 630 includes computer storage media in the form of volatile and/or nonvolatile memory such as read only memory (ROM) 636 and random access memory (RAM) 632. A basic input/output system 633 (BIOS), containing the basic routines that help to transfer information between elements within computer 660, such as during start-up, is typically stored in ROM 636. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 660 may also include other removable/non-removable, volatile/nonvolatile computer storage media. By way of example only, FIG. 6 illustrates a hard disk drive 640 that reads from or writes to non-removable, nonvolatile magnetic media, a magnetic disk drive 656 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 646 is typically connected to the system bus 626 through a non-removable memory interface such as interface 640, and magnetic disk drive 656 and optical disk drive 655 are typically connected to the system bus 626 by a removable memory interface, such as interface 650.

The drives and their associated computer storage media discussed above and illustrated in FIG. 6, provide storage of computer readable instructions, data structures, program modules and other data for the computer 660. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 660 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 691 or other type of display device is also connected to the system bus 626 via an interface, such as a video interface 690. In addition to the monitor, computers may also include other peripheral output devices such as speakers 697 and printer 696, which may be connected through an output peripheral interface 690.

The computer 660 may operate in a networked environment using logical connections to one or more remote computers, such as a remote computer 680. The remote computer 680 may be a personal computer, a server, a router, a network PC, a peer device or other common network node, and typically includes many or all of the elements described above relative to the computer 660, although only a memory storage device 686 has been illustrated in FIG. 6. The logical connections depicted in FIG. 6 include a local area network (LAN) 676 and a wide area network (WAN) 673, but may also include other networks. Such networking environments are commonplace in offices, enterprise-wide computer networks, intranets and the Internet.

When used in a LAN networking environment, the computer 660 is connected to the LAN 676 through a network interface or adapter 670. When used in a WAN networking environment, the computer 660 typically includes a modem 672 or other means for establishing communications over the WAN 673, such as the Internet. The modem 672, which may be internal or external, may be connected to the system bus 626 via the user input interface 660, or other appropriate mechanism. In a networked environment, program modules depicted relative to the computer 660, or portions thereof, may be stored in the remote memory storage device. By way of example, and not limitation, FIG. 6 illustrates remote application programs 685 as residing on memory device 686. It will be appreciated that the network connections shown are exemplary and other means of establishing a communications link between the computers may be used.

The technology is operational with numerous other general purpose or special purpose computing system environments or configurations. Examples of well known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The technology may be described in the general context of computer-executable instructions, such as program modules, being executed by a computer. Generally, program modules include routines, programs, objects, components, data structures, etc. that perform particular tasks or implement particular abstract data types. The technology may also be practiced in distributed computing environments where tasks are performed by remote processing devices that are linked through a communications network. In a distributed computing environment, program modules may be located in both local and remote computer storage media including memory storage devices.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I (We) claim:

1. A method of managing unsolicited email to an email system, the system including a plurality of inbound mail servers, comprising:
storing policies for each unique sender at each of the inbound mail servers in the system;
applying each policy defined for a unique sender to messaging events from the unique sender at a first inbound server;
detecting a violation of a policy by the unique sender resulting from an increase in messaging events at the first inbound server above a threshold severity of events; and
replicating a more restrictive policy to each of the inbound mail servers.

2. The method of claim 1 wherein the system further includes a messaging information system, and the method includes the steps of:
receiving feedback of unique sender activity at each of said inbound messaging servers;
generating the more restrictive policy at said messaging information system; and
wherein said step of replication is performed by said messaging information system.

3. The method of claim 2 wherein the method further includes periodically generating updates to a policy list including policies for each unique sender.

4. The method of claim 2 wherein the step of receiving comprises receiving a feedback sample identifying unique senders and messaging event activity by unique senders and wherein said step of detecting is performed using said feedback sample.

5. The method of claim 1 wherein said step of broadcasting is performed using a connectionless protocol.

6. The method of claim 1 wherein the policy includes limits on at least one of: a total daily bandwidth allocation, a total hourly bandwidth allocation, a total recipient per email message allocation, a total data amount per connection, a total time spent per connection, a total number of messages processed.

7. The method of claim 1 wherein the unique sender is defined by at least one unique internet protocol address.

8. The method of claim 1 wherein the unique sender is defined by at least one of a range of internet protocol addresses or a domain.

9. A method of blocking unsolicited bulk email to an email system, the system including a plurality of distributed inbound mail servers, comprising:
storing policies for each unique sender at each of the inbound mail servers in the system, the unique sender comprising at least one of an internet protocol (IP) address or a range of IP addresses;
applying each policy defined for a unique sender to messaging events from the unique sender at a first inbound server;
detecting a violation of a policy by the unique sender resulting from an increase in messaging events at the first inbound server sufficient to create an alert;
applying a more restrictive policy for the unique sender to each of the inbound mail servers.

10. The method of claim 9 wherein the policy includes limits on at least one of: a total daily bandwidth allocation, a total hourly bandwidth allocation, a total recipient per email message allocation, a total message allocation, a total data amount per connection, a total time spent per connection, a total number of messages processed.

11. The method of claim 10 wherein said step of applying includes replicating the more restrictive policy to each of the plurality of inbound mail servers.

12. The method of claim 10 wherein the method further includes maintaining a policy list including the policies for each known unique sender interacting with the system and periodically distributing updates to the policy list.

13. The method of claim 10 wherein the step of applying includes at least one of denying connection requests to one or more of the plurality of inbound mail servers, and refusing messages with more than a specified number of recipients.

14. The method of claim 13 further including providing a feedback sample identifying unique senders and messaging event activity by unique senders and wherein said step of detecting is performed using said feedback sample.

15. The method of claim 14 wherein the system further includes a messaging information system, and the steps of broadcasting and detecting are performed by the messaging information system.

16. The method of claim 15 wherein the method further includes:
receiving at the messaging information system an indication of the violation as a result of said detection step at said messaging information system; and
generating the more restrictive policy at said messaging information system.

17. A method for throttling inbound email messages in an enterprise email system including a plurality of inbound mail servers and at least one management server, comprising:
creating a policy for processing messaging events from each unique sender of messages to the email system,
storing policies for each unique sender at each of the inbound mail servers in the system;
applying each policy defined for a unique sender to messaging events from the unique sender;
providing feedback from each of the inbound mail servers to the management server;
detecting a violation of a policy by the unique sender sufficient to generate an alert at the management server;
creating a new, more restrictive policy for the unique sender; and
replicating the more restrictive policy to each of the inbound mail servers.

18. The method of claim 17 wherein the step of providing a feedback sample identifying unique senders and messaging event activity by unique senders and wherein said step of detecting is performed using said feedback sample.

19 The method of claim 18 wherein each policy includes limits on at least one of: a total daily bandwidth allocation, a totally hourly bandwidth allocation, a total recipient per email message allocation, a total data amount per connection, a total time spent per connection, a total number of messages processed.

20. The method of claim 19 wherein the unique sender is defined by at least one unique internet protocol address or a range of internet protocol addresses.
